(19) United States
(12) Patent Application Publication
(10) Pub. No.: US 2026/0359330 A1
(43) Pub. Date: Nov. 12, 2026

(54) METHOD, SERVER SYSTEM, AND COMPUTER-READABLE STORAGE MEDIUM FOR EVALUATING RESPONSE QUALITY OF LLM

(71) Applicant: SELECT STAR, INC., Daejeon (KR)

(72) Inventors: BaRom Kang, Hwaseong-si (KR); YongTaek Lim, Yongin-si (KR)

(73) Assignee: SELECT STAR, INC., Daejeon (KR)

(21) Appl. No.: 19/256,665

(22) Filed: Jul. 1, 2025

(30) Foreign Application Priority Data
May 8, 2025 (KR) 10-2025-0059570

(51) Int. Cl. G06F 16/3329; G06F 16/334; G06F 16/34

(52) U.S. Cl. CPC G06F 16/33295; G06F 16/334; G06F 16/345

(57) ABSTRACT

The present invention relates to a method for automatically generating conversation context data and a method, a system, and a computer-readable storage medium for evaluating a response quality of an LLM using the same, and more specifically, to a method for automatically generating conversation context data and a method, a system, and a computer-readable storage medium for evaluating a response quality of an LLM using the same, in which a plurality of nodes including contents of a target document is generated, conversation context data including questions and answers is generated based on contents of the nodes, an answer for the conversation context data is derived through the LLM, and evaluation information about the answer is derived to evaluate the LLM.

### CROSS REFERENCE TO RELATED APPLICATION

The present application claims the right of priority to and the benefits of Korean Application No. 10-2025-0059570 having a filing date of May 8, 2025, the content of which is hereby incorporated by reference in its entirety.

### BACKGROUND OF THE INVENTION

### 1. Field of the Invention

The present invention relates to a method for automatically generating conversation context data and a method, a system, and a computer-readable storage medium for evaluating a response quality of an LLM using the same, and more specifically, to a method for automatically generating conversation context data and a method, a system, and a computer-readable storage medium for evaluating a response quality of an LLM using the same, in which a plurality of nodes including contents of a target document is generated, conversation context data including questions and answers is generated based on contents of the nodes, an answer for the conversation context data is derived through the LLM, and evaluation information about the answer is derived to evaluate the LLM.

### 2. Description of the Related Art

In order to accurately evaluate a response quality of an LLM, it is necessary to understand conversation context and generate appropriate questions and answers based on the conversation context. Since existing methods have usually used passive and fixed datasets, it has been difficult to sufficiently reflect responses in various contexts or situations of conversation, which may reduce the accuracy and reproducibility of response evaluation of the LLM. Since a response capability evaluation technology that reflects the previous conversation context of the existing LLM does not have a retrieval augmented generation (RAG) setting or a fine-grained evaluation method, human inspection is essential in the process of creating a dataset required for evaluation, and a passage required for LLM response has to be directly determined.

Therefore, when a dataset required for evaluating the response capability of the LLM reflecting the previous conversation context is generated, inputting various context according to the capability of the LLM to be evaluated is one of very important factors, and a traversing method of different methods according to the capability of the LLM to be verified in the structured source document has to be applied to create the context. Automated conversation context data generation is an important technology for solving the problem, and automatically generates an appropriate conversation flow for a user's question and enables an accurate evaluation of the response capability of the LLM based on the conversation flow.

In this case, when the conversation context data is automatically generated to evaluate the response quality of the LLM, the performance of the LLM may be accurately evaluated and improved, and accordingly, an automated evaluation system may be constructed and detailed and accurate evaluation may be possible by combining the RAG and fine-grained evaluation. In addition, using the automatically generated conversation dataset may implement an efficient evaluation process, and high-quality response evaluation may be performed without human inspection.

In this situation, there is a demand for a technology capable of automatically generating a dataset for evaluating the response capability of the LLM reflecting the previous conversation context and evaluating the response quality of the LLM.

### SUMMARY OF THE INVENTION

An object of the present invention is to provide a method for automatically generating conversation context data and a method, a system, and a computer-readable storage medium for evaluating a response quality of an LLM using the same, and more specifically, to provide a method for automatically generating conversation context data and a method, a system, and a computer-readable storage medium for evaluating a response quality of an LLM using the same, in which a plurality of nodes including contents of a target document is generated, conversation context data including questions and answers is generated based on contents of the nodes, an answer for the conversation context data is derived through the LLM, and evaluation information about the answer is derived to evaluate the LLM.

To solve the above problem, one embodiment of the present invention provides a method for evaluating a response quality of an LLM, which is performed by a server system including one or more processors and one or more memories, the method including: a chunk extraction step of extracting a plurality of chunks from a target document; a passage network generation step of generating a plurality of passage nodes, each of which includes one or more chunks or information derived from the one or more chunks, and generating a passage network by deriving a connection relationship between the plurality of passage nodes according to similarity between the passage nodes; a conversation context data generation step of generating conversation context data including one or more questions and answers corresponding to each of the questions, based on an arbitrary first passage node and contents for each of a plurality of passage nodes related to the first passage node according to the connection relationship; an evaluation answer derivation step of deriving evaluation answers by inputting the contents for the first passage node and a part of the conversation context data into an evaluation target LLM; and an evaluation information derivation step of deriving evaluation information based on the evaluation answers and the part of the conversation context data.

According to one embodiment of the present invention, the passage network generation step may include: a step of generating contents by summarizing contents of each of the one or more chunks, and generating a plurality of passage nodes including contents thereof; a step of deriving embedding information about each of the plurality of passage nodes, and calculating similarity between the respective passage nodes based on the embedding information; a step of deriving a connection relationship between passage nodes having similarity that is equal to or greater than a preset reference; and a step of generating the passage network including the plurality of passage nodes and the connection relationship between the respective passage nodes.

According to one embodiment of the present invention, the conversation context data generation step may include: a step of generating a first question by selecting an arbitrary first passage node and inputting first content for the first passage node into the LLM; a step of generating a first answer for the first question by inputting the first content and the first question into the LLM; a step of generating a second question by inputting the second content, the first question, and the first answer into the LLM with respect to second content for any one of the passage nodes related to the first passage node; and a step of generating a second answer for the second question by inputting the second content, the first question, the first answer, and the second question into the LLM, and the first question, the first answer, the second question, and the second answer may be included in the conversation context data.

According to one embodiment of the present invention, the method for evaluating a response quality of an LLM may further include a conversation context data review step of reviewing the conversation context data by inputting the conversation context data and the contents for each of the plurality of passage nodes to an LLM outside or inside the server system, in which the conversation context data review step may include: a step of determining whether there is a content mismatch by comparing the conversation context data and the contents for each of the plurality of passage nodes; and a step of determining whether there is an error in questions and answers included in the conversation context data.

According to one embodiment of the present invention, the conversation context data may include n questions and n answers, the evaluation answer derivation step may include deriving the evaluation answers by inputting contents for a specific passage node, the n questions, and (n-1) answers into the evaluation target LLM, and the evaluation information derivation step may include deriving the evaluation information based on one answer that is not input into the evaluation target LLM in the evaluation answer derivation step and the evaluation answers derived from the evaluation target LLM.

According to one embodiment of the present invention, the evaluation information derivation step may include deriving evaluation information about the evaluation answers by comparing an answer that is not input into the evaluation target LLM in the evaluation answer derivation step and similarity between the evaluation answers.

According to one embodiment of the present invention, the evaluation information derivation step may include deriving evaluation information about the evaluation answers by inputting the evaluation answers, the part of the conversation context data, and preset evaluation reference information into the LLM.

To solve the above problem, one embodiment of the present invention provides a server system that includes one or more processors and one or more memories and evaluates a response quality of an LLM, the server system including: a chunk extraction unit configured to extract a plurality of chunks from a target document; a passage network generation unit configured to generate a plurality of passage nodes, each of which includes one or more chunks or information derived from the one or more chunks, and generate a passage network by deriving a connection relationship between the plurality of passage nodes according to similarity between the passage nodes; a conversation context data generation unit configured to generate conversation context data including one or more questions and answers corresponding to each of the questions, based on an arbitrary first passage node and contents for each of a plurality of passage nodes related to the first passage node according to the connection relationship; an evaluation answer derivation unit configured to derive evaluation answers by inputting the contents for the first passage node and a part of the conversation context data into an evaluation target LLM; and an evaluation information derivation unit configured to derive evaluation information based on the evaluation answers and the part of the conversation context data.

To solve the above problem, one embodiment of the present invention provides a computer-readable storage medium for implementing a method for evaluating a response quality of an LLM, which is performed by a server system including one or more processors and one or more memories, in which the computer-readable storage medium includes computer-executable instructions that cause the server system to perform the following steps of: a chunk extraction step of extracting a plurality of chunks from a target document; a passage network generation step of generating a plurality of passage nodes, each of which includes one or more chunks or information derived from the one or more chunks, and generating a passage network by deriving a connection relationship between the plurality of passage nodes according to similarity between the passage nodes; a conversation context data generation step of generating conversation context data including one or more questions and answers corresponding to each of the questions, based on an arbitrary first passage node and contents for each of a plurality of passage nodes related to the first passage node according to the connection relationship; an evaluation answer derivation step of deriving evaluation answers by inputting the contents for the first passage node and a part of the conversation context data into an evaluation target LLM; and an evaluation information derivation step of deriving evaluation information based on the evaluation answers and the part of the conversation context data.

According to one embodiment of the present invention, it is possible to evaluate the response quality of the LLM through the conversation context data generated based on the target document.

According to one embodiment of the present invention, it is possible to extract the plurality of chunks from the target document and generate the passage node based on each chunk.

According to one embodiment of the present invention, it is possible to generate the passage network by deriving the connection relationship according to similarity between the passage nodes based on the embedding information.

According to one embodiment of the present invention, it is possible to generate the conversation context data including questions and answers based on the contents for the passage nodes.

According to one embodiment of the present invention, it is possible to derive the evaluation answer by inputting the contents for the passage nodes and the conversation context data into the evaluation target LLM.

According to one embodiment of the present invention, it is possible to derive the evaluation information about the evaluation target LLM based on the evaluation answer and the conversation context data.

According to one embodiment of the present invention, it is possible to manage the quality of conversation context data by reviewing the conversation context data through the LLM.

According to one embodiment of the present invention, it is possible to derive the evaluation information about the evaluation answer by comparing the similarity between the evaluation answer and the conversation context data.

According to one embodiment of the present invention, it is possible to derive the evaluation information about the evaluation answer by inputting the evaluation answer, the conversation context data, and the evaluation criterion information into the LLM.

### BRIEF DESCRIPTION OF THE DRAWINGS

FIG. 1 schematically illustrates an internal configuration of a server system according to one embodiment of the present invention.

FIG. 2 schematically illustrates a process of performing a chunk extraction step according to one embodiment of the present invention.

FIGS. 3A and 3B schematically illustrate a process of performing a passage network generation step according to one embodiment of the present invention.

FIG. 4 schematically illustrates a process of performing a conversation context data generation step according to one embodiment of the present invention.

FIG. 5 schematically illustrates a process of performing an evaluation answer derivation step according to one embodiment of the present invention.

FIGS. 6A and 6B schematically illustrates a process of performing an evaluation information derivation step according to one embodiment of the present invention.

FIG. 7 schematically illustrates an example of contents, conversation context data, and an evaluation answer according to one embodiment of the present invention.

FIG. 8 schematically illustrates a process of performing a conversation context data review step according to one embodiment of the present invention.

FIG. 9 schematically shows internal components of the computing device according to one embodiment of the present invention.

### DETAILED DESCRIPTION OF THE INVENTION

Hereinafter, various embodiments and/or aspects will be described with reference to the drawings. In the following description, numerous specific details are set forth in order to provide a thorough understanding of one or more aspects for the purpose of explanation. However, it will also be appreciated by a person having ordinary skill in the art that such aspect(s) may be carried out without the specific details. The following description and accompanying drawings will be set forth in detail for specific illustrative aspects among one or more aspects. However, the aspects are merely illustrative, some of various ways among principles of the various aspects may be employed, and the descriptions set forth herein are intended to include all the various aspects and equivalents thereof.

In addition, various aspects and features will be presented by a system that may include a plurality of devices, components and/or modules or the like. It will also be understood and appreciated that various systems may include additional devices, components and/or modules or the like, and/or may not include all the devices, components, modules or the like recited with reference to the drawings.

The term “embodiment”, “example”, “aspect”, “exemplification”, or the like as used herein may not be construed in that an aspect or design set forth herein is preferable or advantageous than other aspects or designs. The terms ‘unit’, ‘component’, ‘module’, ‘system’, ‘interface’ or the like used in the following generally refer to a computer-related entity, and may refer to, for example, hardware, software, or a combination of hardware and software.

In addition, the terms “include” and/or “comprise” specify the presence of the corresponding feature and/or component, but do not preclude the possibility of the presence or addition of one or more other features, components or combinations thereof.

In addition, the terms including an ordinal number such as first and second may be used to describe various components, however, the components are not limited by the terms. The terms are used only for the purpose of distinguishing one component from another component. For example, the first component may be referred to as the second component without departing from the scope of the present invention, and similarly, the second component may also be referred to as the first component. The term “and/or” includes any one of a plurality of related listed items or a combination thereof.

In addition, in embodiments of the present invention, unless defined otherwise, all terms used herein including technical or scientific terms have the same meaning as commonly understood by those having ordinary skill in the art. Terms such as those defined in generally used dictionaries will be interpreted to have the meaning consistent with the meaning in the context of the related art, and will not be interpreted as an ideal or excessively formal meaning unless expressly defined in the embodiment of the present invention.

The “user terminal” referred to below may be implemented as a computer or portable terminal that can access a server or other terminals through a network. The computer may include, for example, a notebook computer, a desktop, a laptop, and the like installed with a web browser, and the portable terminal may include all kinds of handheld-based wireless communication device such as smartphone, personal communication system (PCS), global system for mobile communications (GSM), personal digital cellular (PDC), personal handyphone system (PHS), personal digital assistant (PDA), international mobile telecommunication (IMT)-2000, code division multiple access (CDMA)-2000, W-code division multiple access (W-CDMA), wireless broadband internet (Wibro), or bluetooth low energy (BLE) beacon terminal. In addition, “network” may be implemented by a wired network such as a local area network (LAN), a wide area network (WAN) or a value added network (VAN), and all types of wireless network such as a mobile radio communication network, or a satellite network.

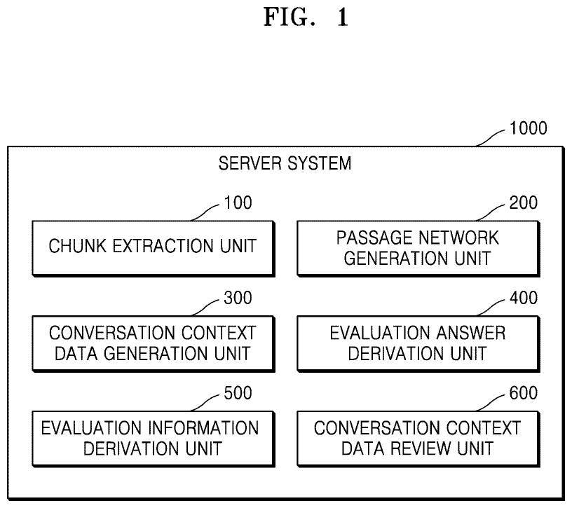

FIG. 1 schematically illustrates a connection configuration and an internal configuration of a server system 1000 according to one embodiment of the present invention.

As illustrated in FIG. 1, the server system 1000 includes: a chunk extraction unit (i.e., a chunk extraction module) 100 that performs a chunk extraction step of extracting a plurality of chunks from a target document; a passage network generation unit (i.e., a passage network generation module) 200 that performs a passage network generation step of generating a plurality of passage nodes, each of which includes one or more chunks or information derived from the one or more chunks, and generating a passage network by deriving a connection relationship between the plurality of passage nodes according to similarity between the passage nodes; a conversation context data generation unit (i.e., a conversation context data generation module) 300 that performs a conversation context data generation step of generating conversation context data including one or more questions and answers corresponding to each of the questions, based on an arbitrary first passage node and contents for each of a plurality of passage nodes related to the first passage node according to the connection relationship; an evaluation answer derivation unit (i.e., an evaluation answer derivation module) 400 that performs an evaluation answer derivation step of deriving evaluation answers by inputting the contents for the first passage node and a part of the conversation context data into an evaluation target LLM 2000; an evaluation information derivation unit (i.e., an evaluation information derivation module) that performs an evaluation information derivation step of deriving evaluation information based on the evaluation answers and the part of the conversation context data; and a conversation context data review unit 600 that performs a conversation context data review step of reviewing the conversation context data by inputting the conversation context data and the contents for each of the plurality of passage nodes to an LLM outside or inside the server system 1000.

More specifically, each configuration included in the server system 1000 illustrated in FIG. 1 serves to control an operation of the server system 1000 that performs the method for evaluating a response quality of an LLM of the present invention.

More specifically, the chunk extraction unit 100 of the server system 1000 may extract the plurality of chunk from the target document.

According to one embodiment of the present invention, the chunk extraction step may include deriving the plurality of chunks in a paragraph unit from the target document, deriving the plurality of chunks in a semantic unit, or deriving the plurality of chunks by inputting the target document into an LLM outside or inside the server system 1000.

The passage network generation unit 200 of the server system 1000 may generate a plurality of passage nodes, each of which includes one or more chunks or information derived from the one or more chunks, and generate the passage network by deriving a connection relationship between the plurality of passage nodes according to similarity between the passage nodes.

According to one embodiment of the present invention, the passage network generation step may include: a step of generating contents by summarizing contents of each of the one or more chunks, and generating a plurality of passage nodes including contents thereof; a step of deriving embedding information about each of the plurality of passage nodes, and calculating similarity between the respective passage nodes based on the embedding information; a step of deriving a connection relationship between passage nodes having similarity that is equal to or greater than a preset reference; and a step of generating the passage network including the plurality of passage nodes and the connection relationship between the respective passage nodes.

The conversation context data generation unit 300 of the server system 1000 may generate conversation context data including one or more questions and answers corresponding to each of the questions, based on an arbitrary first passage node and contents for each of a plurality of passage nodes related to the first passage node according to the connection relationship.

According to one embodiment of the present invention, the conversation context data generation step may include: a step of generating a first question by selecting an arbitrary first passage node and inputting first content for the first passage node into the LLM; a step of generating a first answer for the first question by inputting the first content and the first question into the LLM; a step of generating a second question by inputting the second content, the first question, and the first answer into the LLM with respect to second content for any one of the passage nodes related to the first passage node; and a step of generating a second answer for the second question by inputting the second content, the first question, the first answer, and the second question into the LLM, and the first question, the first answer, the second question, and the second answer may be included in the conversation context data.

The evaluation answer derivation unit 400 of the server system 1000 may derive the evaluation answers by inputting the content for the first passage node and the part of the conversation context data into the evaluation target LLM 2000.

According to one embodiment of the present invention, the conversation context data may include n questions and n answers, the evaluation answer derivation step may include deriving the evaluation answers by inputting contents for a specific passage node, the n questions, and (n-1) answers into the evaluation target LLM 2000, and the evaluation information derivation step may include deriving the evaluation information based on one answer that is not input into the evaluation target LLM 2000 in the evaluation answer derivation step and the evaluation answers derived from the evaluation target LLM.

In this case, the evaluation target LLM 2000 is the LLM located outside or inside the server system 1000, and may correspond to a model that corresponds to a target for evaluating the response quality in the present invention and derives evaluation answers including an answer for a specific question when the contents and the part of the conversation context data including the specific question are input. The evaluation answer may include all answers derived from the evaluation target LLM 2000.

The evaluation information derivation unit 500 of the server system 1000 may derive the evaluation information based on the evaluation answers and the part of the conversation context data.

According to one embodiment of the present invention, the evaluation information derivation step may include deriving evaluation information about the evaluation answers by comparing an answer that is not input into the evaluation target LLM 2000 in the evaluation answer derivation step and similarity between the evaluation answers.

In addition, the evaluation information derivation step may include deriving evaluation information about the evaluation answers by inputting the evaluation answers, the part of the conversation context data, and preset evaluation reference information into the LLM.

The conversation context data review unit 600 of the server system 1000 may review the conversation context data by inputting the conversation context data and the contents for each of the plurality of passage nodes into the LLM outside or inside the server system 1000.

According to one embodiment of the present invention, the conversation context data review step may include: a step of determining whether there is a content mismatch by comparing the conversation context data and the contents for each of the plurality of passage nodes; and a step of determining whether there is an error in questions and answers included in the conversation context data.

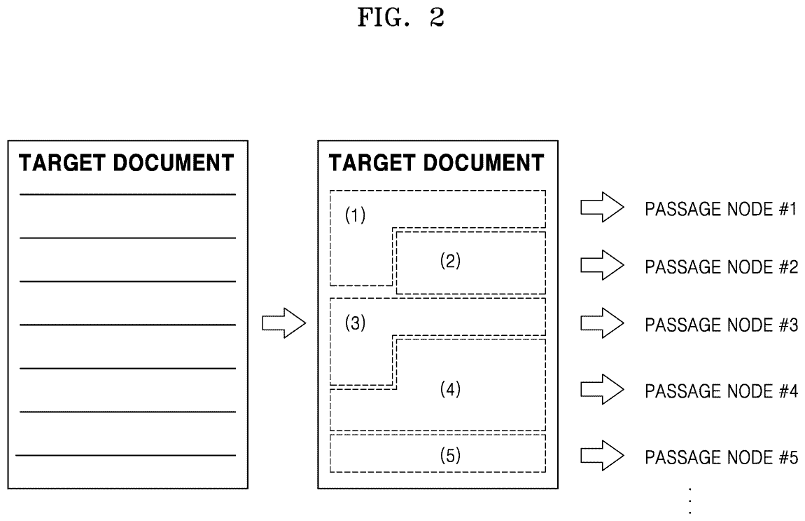

FIG. 2 schematically illustrates a process of performing a chunk extraction step according to one embodiment of the present invention.

Schematically, the chunk extraction step may include extracting the plurality of chunks from the target document.

As illustrated in FIG. 2, the plurality of chunks may be extracted from the target document including a plurality of page, and subsequently, passage nodes including each of the chunks may be generated. A plurality of chunks including (1) to (5) may be extracted from the target document of FIG. 2, and a plurality of passage nodes #1 to #5 may be subsequently generated based on (1) to (5), respectively.

Preferably, one or more chunks may be extracted from the respective pages of the target document including the plurality of pages, and different numbers of chunks may be extracted from the respective pages according to a paragraph or a semantic unit. As for the target document including the plurality of pages, a larger number of chunks may be extracted than those illustrated in FIG. 2, and thus a larger number of passage nodes may be subsequently generated. The target document may correspond to a document including hundreds of pages, and thus the amount of conversation context data may increase according to the target document.

In this case, the chunk extraction step may include deriving the plurality of chunks in a paragraph unit from the target document, deriving the plurality of chunks in a semantic unit, or deriving the plurality of chunks by inputting the target document into the LLM outside or inside the server system 1000.

According to one embodiment of the present invention, each target document may be chunked and divided into chunks, and a passage network for each of a plurality of target documents may be generated in the server system 1000. Accordingly, the contents of the document included in the target document may be divided into one or more chunks by chunking the target document of FIG. 2, and (1) to (5) of FIG. 2 may correspond to the respective chunks of the target document. Just in case, when there are a plurality of target documents, the number of chunks extracted from each of the target documents may be derived to be the same as or different from each other.

Preferably, the chunking may include a process of creating chunks by meaningfully binding information to each other, and the chunking may be performed based on a paragraph, a sentence, a word, and the like in the contents of the target document. Therefore, the chunks may be extracted in a text format, and each of the chunks may include text.

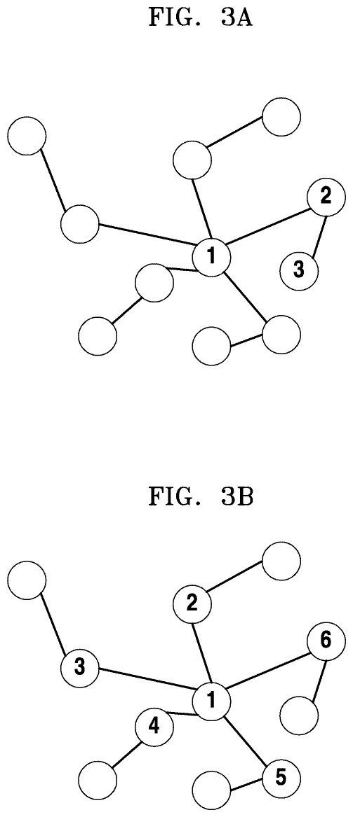

FIGS. 3A and 3B schematically illustrate a process of performing a passage network generation step according to one embodiment of the present invention.

Schematically, FIG. 3A illustrates a process of performing a step of searching for a passage network using a first method, and FIG. 3B illustrates a step of performing a step of searching for a passage network using a second method.

Specifically, the passage network generation step may include generating a plurality of passage nodes, each of which includes one or more chunks or information derived from the one or more chunks, and generating a passage network by deriving a connection relationship between the plurality of passage nodes according to similarity between the passage nodes.

More specifically, the passage network generation step may include: a step of generating contents by summarizing contents of each of the one or more chunks, and generating a plurality of passage nodes including contents thereof; a step of deriving embedding information about each of the plurality of passage nodes, and calculating similarity between the respective passage nodes based on the embedding information; a step of deriving a connection relationship between passage nodes having similarity that is equal to or greater than a preset reference; and a step of generating the passage network including the plurality of passage nodes and the connection relationship between the respective passage nodes.

As illustrated in FIGS. 3A and 3B, a plurality of passage nodes including one or more chunks may be generated, or a plurality of passage nodes according to the plurality of chunks extracted from the target document may be generated by generating the plurality of passage nodes including information derived from the one or more chunks. In addition, a passage network may be generated by deriving a connection relationship between the plurality of passage nodes according to similarity between the plurality of passage nodes.

In this case, the information derived from the one or more chunks may correspond to information obtained by summarizing the contents of each of the one or more chunks, the plurality of passage nodes may include contents thereof, and each of the passage nodes may include contents having the contents of one chunk as they are, include contents obtained by summarizing the contents of one chunk, or include contents obtained by summarizing the contents of the plurality of chunks.

In addition, in order to derive the connection relationship between the plurality of passage nodes, embedding information about each of the plurality of passage nodes may be derived, similarity between the respective passage nodes may be calculated based on the embedding information, and the connection relationship between the passage nodes having similarity that is equal to or greater than a preset reference may be derived. Each of the nodes illustrated in FIGS. 3A and 3B corresponds to a passage node, and the connection relationship between the passage nodes may be shown by linearly connecting one passage node and another passage node.

According to one embodiment of the present invention, according to an embedding value of the passage node, there may be a specific passage node that does not have information about a connection relationship with another passage node from among the plurality of passage nodes, a specific passage node that has information about a connection relationship with one other passage node, and a specific passage node that has information about the connection relationship with the plurality of passage nodes.

Preferably, the passage network including the plurality of passage nodes and the connection relationship between the respective passage nodes may be generated, and each of FIGS. 3A and 3B may correspond to one passage network.

According to one embodiment of the present invention, the passage network generation step may include deriving contents obtained by summarizing each of the chunks or contents obtained by summarizing one or more similar chunks by inputting the plurality of chunks into the LLM, generating a plurality of passage nodes including each of the contents, and deriving a connection relationship between the plurality of passage nodes based on similarity by inputting the plurality of passage nodes into the LLM.

According to another embodiment of the present invention, the conversation context data may include first conversation context data and second conversation context data, and the conversation context data generation step may include generating the first conversation context data by determining an arbitrary first passage node and searching for a plurality of passage nodes related to the first passage node using a depth-first search (DFS) method, and generating the second conversation context data by determining an arbitrary first passage node and searching for a plurality of passage nodes related to the first passage node using a breadth-first search (BFS) method.

As illustrated in FIG. 3A, after the server system 1000 generates the passage network, the conversation context data may be generated based on the passage network, and when the plurality of passage nodes included in the passage network are searched in order to generate the conversation context data, the passage network may be searched using a preset first method. Preferably, the preset first method may correspond to the DFS method, and as illustrated in FIG. 3A, when Node 1 is determined as the first passage node, the first conversation context data may be generated by searching for the passage node in an order of Node 2 and Node 3 using the DFS method.

As illustrated in FIG. 3B, after the server system 1000 generates the passage network, the conversation context data may be generated based on the passage network, and when the plurality of passage nodes included in the passage network are searched in order to generate the conversation context data, the passage network may be searched using a preset second method. Preferably, the preset second method may correspond to the BFS method, and as illustrated in FIG. 3B, when Node 1 is determined as the first passage node, the second conversation context data may be generated by searching for the passage node in an order of Node 2, Node 3, Node 4, Node 5, and Node 6 using the BFS method.

According to one embodiment of the present invention, the DFS method may be used to evaluate the inference capability of adding depth to the LLM to be evaluated in the present invention, and the BFS method may be used to evaluate the capability of understanding a wide range of contents with respect to the LLM to be evaluated and answering to the contents in the present invention.

Therefore, the first conversation context data may be used as data for evaluating RAG for DFS, and the second conversation context data may be used as data for evaluating RAG for BFS.

Preferably, in the method for evaluating a response quality of an LLM, the conversation context data may be generated by determining the search order of the passage network through any one or more of the first method and the second method according to situations such as the type of the evaluation target LLM 2000, the form of the passage node, and data. Therefore, according to the present invention, since new conversation context data is generated by reflecting the conversation context data that has been previously generated, mutually different conversation context data may be generated according to the search order of the passage node, that is, mutually different conversation context data may be generated according to each of the first method and the second method.

According to one embodiment of the present invention, contents obtained by summarizing one or more similar chunks may be generated by inputting the plurality of extracted chunks into the LLM outside or inside the server system 1000. The passage node may include the contents of the extracted chunks as they are, or may include information derived based on the chunks.

In addition, as illustrated in FIGS. 3A and 3B, a central node, which is located at the center of the passage network having a central node, may include a summary of one or more other passage nodes having a connection relationship, or a parent node in the passage network having a tree form may include a summary of one or more child nodes having a connection relationship.

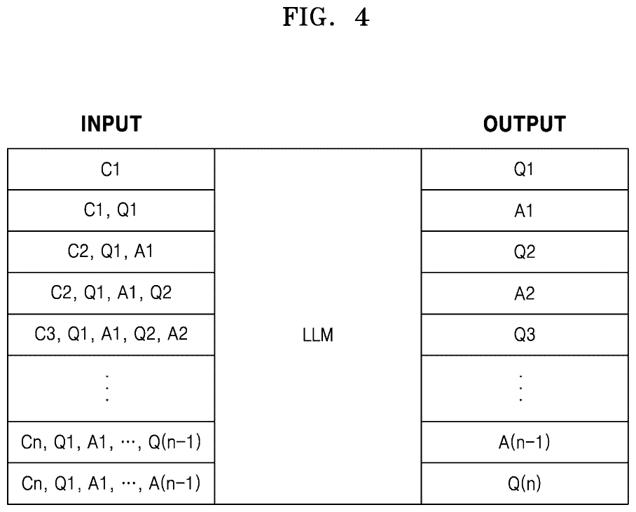

FIG. 4 schematically illustrates a process of performing a conversation context data generation step according to one embodiment of the present invention.

Schematically, the conversation context data generation step may include generating conversation context data including one or more questions and answers corresponding to each of the questions, based on an arbitrary first passage node and contents for each of a plurality of passage nodes related to the first passage node according to the connection relationship.

Specifically, the conversation context data generation step may include: a step of generating a first question by selecting an arbitrary first passage node and inputting first content for the first passage node into the LLM; a step of generating a first answer for the first question by inputting the first content and the first question into the LLM; a step of generating a second question by inputting the second content, the first question, and the first answer into the LLM with respect to second content for any one of the passage nodes related to the first passage node; and a step of generating a second answer for the second question by inputting the second content, the first question, the first answer, and the second question into the LLM, and the first question, the first answer, the second question, and the second answer may be included in the conversation context data.

More specifically, an arbitrary first passage node may be selected from among the plurality of passage nodes, a first question related to the first content may be generated by inputting the first content for the first passage node into the LLM outside or inside the server system 1000, and a first answer for the first question may be generated by inputting the first content and the first question into the LLM.

In addition, as for second content for any one passage node related to the first passage node, a second question may be generated by inputting the second content, the first question, and the first answer into the LLM, and in this case, the any one passage node related to the first passage node may be determined based on the first method or the second method.

Thereafter, a second answer for the second question may be generated by inputting the second content, the first question, the first answer, and the second question into the LLM.

According to one embodiment of the present invention, by repeating the above method, questions and answers for all the passage nodes included in the passage network may be generated, or questions and answers for a part of the passage nodes included in the passage network may be generated. That is, each of the passage nodes in the passage network may have questions and answers corresponding thereto.

As illustrated in FIG. 4, in a case where C corresponds to content included in each of the plurality of passage nodes, Q corresponds to a question, A corresponds to an answer corresponding to the question, and n corresponds to a natural number of 1 or more, when there are n passage nodes in the passage network, questions and answers for each of the n passage nodes may be generated.

For example, C1 corresponding to the first content for the first passage node may be input into the LLM to generate Q1 corresponding to the first question related to C1, and C1 and Q1 may be input into the LLM to generate A1 corresponding to the first answer corresponding to Q1. In addition, C2, Q1, and A1 may be input into the LLM to generate Q2 related to C2, and C2, Q1, A1, and Q2 may be input into the LLM to generate A2 corresponding to Q2.

Accordingly, Cn, Q1, A1, . . . , A(n-1) may be finally input into the LLM to generate Q(n), and in this case, Cn, Q1, A1, . . . , Q(n) may be input into the LLM to generate A(n) for Q(n). That is, questions and answers for all of the n passage nodes may be generated and stored in the server system 1000.

In this case, the reason why Q1 and A1 are input into the LLM together when generating Q2 is to generate a question reflecting the context of the entire passage network when generating a question for each of the passage nodes, and the reason why Q1 and A1 are input into the LLM together when generating A2 for Q2 is to generate a more accurate answer in consideration of the context of the entire passage network when generating an answer for each question.

When Q2 is generated by inputting only C2 into the LLM without inputting Q1 and A1, a plurality of questions generated for each of the plurality of passage nodes may include questions irrelevant to each other, and may include a question deviating from the context of the entire target document.

Preferably, the first question, the first answer, the second question, and the second answer may be included in conversation context data, and the conversation context data may include all questions and all answers for each of the plurality of passage nodes.

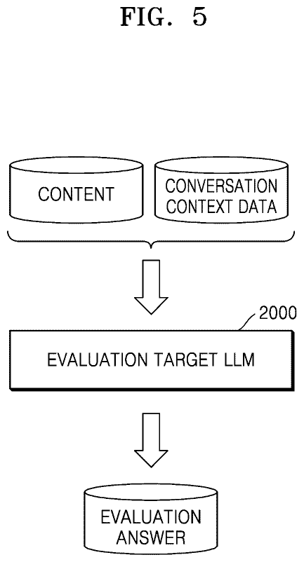

FIG. 5 schematically illustrates a process of performing an evaluation answer derivation step according to one embodiment of the present invention.

Schematically, the evaluation answer derivation step may include deriving the evaluation answer by inputting the content for the first passage node and the part of the conversation context data into the evaluation target LLM 2000.

Specifically, based on FIG. 4, the conversation context data may include n questions and n answers, and in this case, the evaluation answer derivation step may include deriving the evaluation answer by inputting contents for a specific passage node, all of the n questions, and (n-1) answers into the evaluation target LLM 2000. Thereafter, the evaluation information derivation step may include deriving the evaluation information based on one answer that is not input into the evaluation target LLM 2000 in the evaluation answer derivation step and the evaluation answers derived from the evaluation target LLM 2000.

As illustrated in FIG. 5, the evaluation answer may be derived by inputting the contents for the arbitrary first passage node, the n questions, and (n-1) answers into the evaluation target LLM 2000. For example, based on FIG. 4, all of Cn, Q1 to Qn, and all of A1 to A(n-1) may be input into the evaluation target LLM 2000 to derive evaluation answers including an answer for Qn. In this case, the evaluation answers may include all responses derived from the evaluation target LLM 2000 as the answers for Qn.

When it is intended to derive evaluation answers for Q1, all of C1, Q1 to Qn, and all of A2 to An may be input into the evaluation target LLM 2000 to derive evaluation answers including the answer for Q1.

According to one embodiment of the present invention, the evaluation answer derivation step may include deriving the evaluation answers by inputting all contents for each of the plurality of passage nodes and the part of the conversation context data into the evaluation target LLM 2000.

When the evaluation answers including the answer for Qn are derived by inputting Cn, Q1 to Qn, and A1 to A(n-1) into the evaluation target LLM 2000, the evaluation target LLM 2000 may derive the evaluation answer for Q1 based on Cn, and may derive an evaluation answer suitable for the entire context based on Q1 to Q(n-1) and A1 to A(n-1).

In addition, when the evaluation answers including the answer for Qn are derived by inputting C1 to Cn, Q1 to Qn, and A1 to A(n-1) into the evaluation target LLM 2000, the evaluation target LLM 2000 may derive the evaluation answers for Q1 based on C1 to Cn, and may derive evaluation answers suitable for all contexts based on Q1 to Q(n-1) and A1 to A(n-1).

Therefore, since the evaluation target LLM 2000 can derive the evaluation answer by grasping the entire context, a more accurate evaluation answer may be derived, and in the method for evaluating a response quality of an LLM according to the present invention, the response quality of the evaluation target LLM 2000 can be determined to be higher.

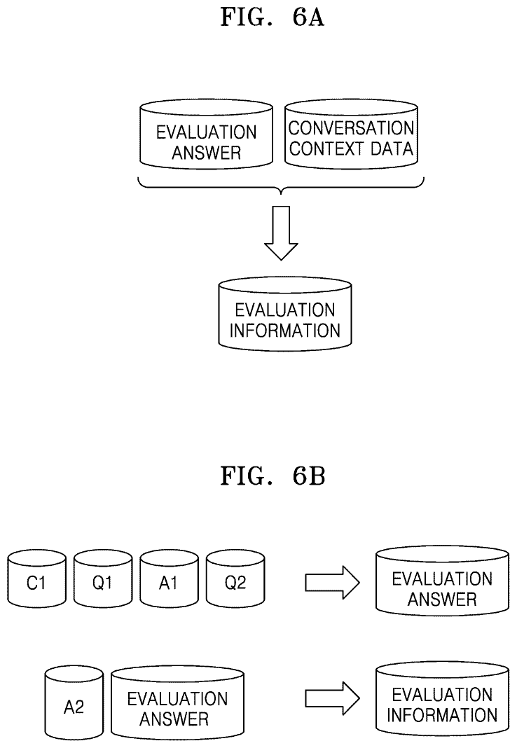

FIGS. 6A and 6B schematically illustrate a process of performing an evaluation information derivation step according to one embodiment of the present invention.

Schematically, FIG. 6A illustrates a process of performing the evaluation information derivation step, and FIG. 6B illustrates an example of the evaluation information derivation step.

Specifically, the evaluation information derivation step may include deriving evaluation information based on the evaluation answer and the part of the conversation context data.

According to one embodiment of the present invention, the evaluation information derivation step may include deriving evaluation information about the evaluation answers by comparing an answer that is not input into the evaluation target LLM 2000 in the evaluation answer derivation step and similarity between the evaluation answers.

In addition, the evaluation information derivation step may include deriving evaluation information about the evaluation answers by inputting the evaluation answers, the part of the conversation context data, and preset evaluation reference information into the LLM.

More specifically, the conversation context data may include n questions and n answers, the evaluation answer derivation step may include deriving the evaluation answers by inputting contents for a specific passage node, the n questions, and (n-1) answers into the evaluation target LLM 2000, and the evaluation information derivation step may include deriving the evaluation information based on one answer that is not input into the evaluation target LLM 2000 in the evaluation answer derivation step and the evaluation answers derived from the evaluation target LLM.

As illustrated in FIG. 6A, the evaluation information may be derived based on the evaluation answers derived from the evaluation target LLM 2000 and the part of the conversation context data, and in this case, the part of the conversation context data may correspond to conversation context data that is not input into the evaluation target LLM 2000 in the evaluation answer derivation step from among the conversation context data.

When the evaluation answers including the answer for Qn are derived by inputting Cn, Q1 to Qn, and A1 to A(n-1) into the evaluation target LLM 2000 in the evaluation answer derivation step, the evaluation information derivation step may include deriving the evaluation information by comparing the evaluation answers derived from the evaluation target LLM 2000 and An corresponding to Qn.

According to one embodiment of the present invention, the evaluation information may be derived as a score including a value in a numeric form or may be derived in a text form. Since the evaluation information about the evaluation answers may be derived by comparing the similarity between the answer of the conversation context data, which is not input into the evaluation target LLM 2000 in the evaluation answer derivation step, and the evaluation answers, the evaluation information may be derived based on the similarity between An and the evaluation answers, and the higher the similarity between An and the evaluation answers, the higher the value for the evaluation information may be derived.

That is, the higher the similarity between the answer of the conversation context data, which is not input into the evaluation target LLM 2000 in the evaluation answer derivation step, and the evaluation answers, the higher the value for the evaluation information may be derived.

According to another embodiment of the present invention, the evaluation information about the evaluation answers may be derived by inputting the evaluation answers, the part of the conversation context data, and preset evaluation reference information into the LLM, and in this case, since the part of the conversation context data includes an answer of the conversation context data, which is not input into the evaluation target LLM 2000 in the evaluation answer derivation step, the evaluation answers, the answer of the conversation context data, which is not input into the evaluation target LLM 2000 in the evaluation answer derivation step, and the evaluation information about the evaluation answers may be derived by inputting the evaluation answers, the answer of the conversation context data, which is not input into the evaluation target LLM 2000 in the evaluation answer derivation step into the LLM outside or inside the server system 1000. For example, the evaluation information may be derived by inputting the An, the evaluation answer, and the preset evaluation reference information into the LLM.

As illustrated in FIG. 6B, when the evaluation answers are derived in the evaluation answer derivation step by inputting the content corresponding to C2 and the part of the conversation context data including Q1, A1, and Q2 into the evaluation target LLM 2000, the evaluation information derivation step may include deriving the evaluation information about the evaluation answers by comparing A2 and the evaluation answer.

In this case, since the evaluation answer corresponds to an answer for the question corresponding to Q2, which is derived by the evaluation target LLM 2000, and A2 corresponds to a pre-stored answer corresponding to the question corresponding to Q2, as the evaluation answer is similar to A2, the evaluation target LLM 2000 may be evaluated as a high-quality LLM that derives an accurate answer.

Preferably, since the conversation context data including questions and answers for each of the plurality of passage nodes is generated in the conversation context data generation step, there may be pre-stored answers for all questions in the server system 1000, and thus, the response quality of the evaluation target LLM 2000 may be evaluated by deriving evaluation information about the evaluation answer.

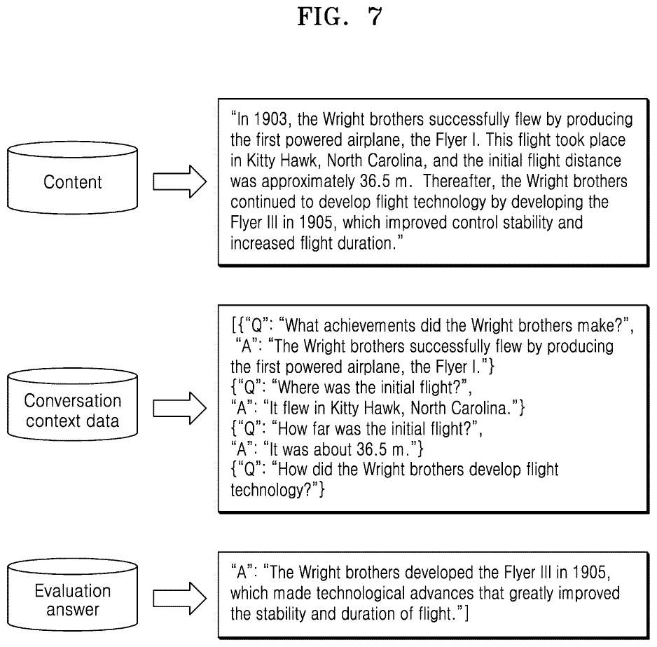

FIG. 7 schematically illustrates an example of contents, conversation context data, and an evaluation answer according to one embodiment of the present invention.

Schematically, the contents of the passage nodes may include each of the chunks extracted from the target document or a summary of each of the chunks, the conversation context data may include questions and answers for the contents for each of the passage nodes, and the evaluation answer may include an answer of the evaluation target LLM 2000 for any one question of the conversation context data.

As illustrated in FIG. 7, the content of the passage node may include the following text: “In 1903, the Wright brothers successfully flew by producing the first powered airplane, the Flyer I. This flight took place in Kitty Hawk, North Carolina, and the initial flight distance was approximately 36.5 m. Thereafter, the Wright brothers continued to develop flight technology by developing the Flyer III in 1905, which improved control stability and increased flight duration.”

The conversation context data may include texts such as {“Q1”: “What achievements did the Wright brothers make?”, “A1”: “The Wright brothers successfully flew by producing the first powered airplane, the Flyer I.”}, {“Q2”: “Where was the initial flight?”, “A2”: “It flew in Kitty Hawk, North Carolina.”}, {“Q3”: “How far was the initial flight?”, “A3”: “It was about 36.5 m.”}, and {“Q4”: “How did the Wright brothers develop flight technology?”}, and since the conversation context data includes questions and answers corresponding thereto in the present invention, the conversation context data of FIG. 7 may corresponds to a part of the entire conversation context data.

The evaluation answer may include the text “A”: “The Wright brothers developed the Flyer III in 1905, which made technological advances that greatly improved the stability and duration of flight.”

In this case, each of Q1 to Q4 may correspond to a first question to a fourth question, each of A1 to A3 may correspond to a first answer for a third answer, and the first question to the fourth question and the first answer for the fourth answer may be stored in the server system.

According to one embodiment of the present invention, in the contents of FIG. 7, the first sentence may correspond to first content for a first passage node, the second sentence may correspond to second content for a second passage node, and the third sentence may correspond to third content for a third passage node.

In this case, there may be conversation context data about each of the first to third passage nodes, and the first question and answer in the conversation context data of FIG. 7 may correspond to the first question and the first answer for the first content, the second question and answer may correspond to the second question and the second answer for the second content, and the third question may correspond to the third question for the third content. Preferably, an answer corresponding to the question for the third content may be stored in the conversation context data of the server system 1000.

Just in case, in order to derive an evaluation answer for the third question in the evaluation answer derivation step, the evaluation answer may be derived by inputting the third content, the first to third questions, and the first to second answers into the evaluation target LLM 2000, and in this case, the evaluation target LLM 2000 may derive the text “The Wright brothers developed the Flyer III in 1905, which made technological advances that greatly improved the stability and duration of flight.” as the evaluation answer for the third question based on the third content “Thereafter, the Wright brothers continued to develop flight technology by developing the Flyer III in 1905, which improved control stability and increased flight duration.”

Alternatively, in order to derive the evaluation answer for the third question in the evaluation answer derivation step, the evaluation answer may be derived by inputting the first content to the third content, the first question to the third question, and the first answer for the second answer into the evaluation target LLM 2000, and in this case, the evaluation target LLM 2000 may derive the text “The Wright brothers developed the Flyer III in 1905, which made technological advances that greatly improved the stability and duration of flight.” as the evaluation answer for the third question based on the firs content to the third content “In 1903, the Wright brothers successfully flew by producing the first powered airplane, the Flyer I. This flight took place in Kitty Hawk, North Carolina, and the initial flight distance was approximately 36.5 m. Thereafter, the Wright brothers continued to develop flight technology by developing the Flyer III in 1905, which improved control stability and increased flight duration.”

Therefore, when all contents including the first content to the third content is input into the evaluation target LLM 2000 compared to when only the third content is input into the evaluation target LLM 2000, the evaluation target LLM 2000 may grasp the entire context of the contents to derive a more accurate evaluation answer.

Thereafter, the evaluation information may be derived by comparing the third answer for the third question stored in the server system 1000 and the evaluation answer, and the response quality of the evaluation target LLM 2000 may be evaluated according to the evaluation information.

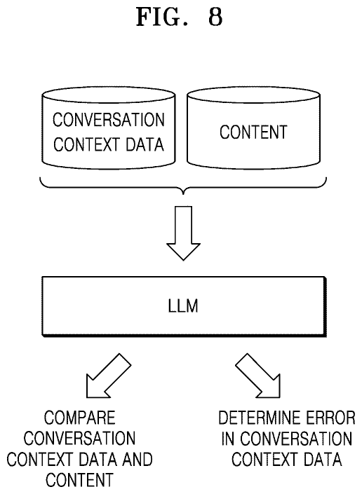

FIG. 8 schematically illustrates a process of performing a conversation context data review step according to one embodiment of the present invention.

Schematically, the conversation context data review step may include reviewing the conversation context data by inputting the conversation context data and the contents for each of the plurality of passage nodes into the LLM outside or inside the server system 1000.

Specifically, the conversation context data review step may include: a step of determining whether there is a content mismatch by comparing the conversation context data and the contents for each of the plurality of passage nodes; and a step of determining whether there is an error in questions and answers included in the conversation context data.

According to one embodiment of the present invention, the conversation context data may be reviewed by inputting the conversation context data and the contents for each of the plurality of passage nodes into the LLM outside or inside the server system 1000, or the conversation context data may be reviewed by inputting the conversation context data into the LLM outside or inside the server system 1000.

As illustrated in FIG. 8, in the conversation context data review step, a review for the conversation context data generated in the conversation context data generation step may be performed. Preferably, it is possible to review whether there is incorrect content in the generated context data, whether there is a correlation between questions, whether there is a question out of context, and the like.

In this case, the conversation context data may be reviewed by inputting the entire or part of the generated conversation context data and all contents for each of the plurality of passage nodes may be input into the LLM outside or inside the server system 1000. When the conversation context data is reviewed, it is possible to determine whether there is mismatch content, such as including questions and answers irrelevant to the content or including questions and answers deviating from the context, by comparing the conversation context data and the content, and it is possible to determine whether there is an error, such as generation of an incorrect answer for a question, by checking the questions and the answers included in the conversation context data.

The method for evaluating a response quality of an LLM of the present invention may evaluate the response quality of the evaluation target LLM 2000 including an RAG system. That is, when the existing information and questions are input into the evaluation target LLM 2000 to be evaluated, it is possible to check how well the answers for the questions are inferred.

Accordingly, the response quality for each of a plurality of evaluation target LLMs 2000 may be evaluated through one conversation context data generated by the server system 1000, and the response quality for the evaluation target LLM 2000 may be accurately evaluated through one or more of a plurality of questions included in the conversation context data.

In particular, according to the present invention, it is possible to generate conversation context data for evaluating the response capability reflecting the previous conversation context in a RAG setting of the LLM and evaluate the response capability of the LLM using the conversation context data. In this case, the conversation context data may be generated through an appropriate passage node without human intervention using a passage network in which the target document is structured, and the conversation context data may be efficiently generated by searching for the structured passage network in different ways according to the capability of the evaluation target LLM 2000 to be evaluated.

In addition, it is possible to determine whether the conversation context data is suitable data capable of evaluating the response quality of the evaluation target LLM 2000 by reviewing the conversation context data generated by the LLM through the conversation context data review step, and it is possible to evaluate whether the evaluation target LLM 2000 shows the good inference capability in conversations requiring the deeper inference capability and conversations requiring a wide range through the first conversation context data and the second conversation context data.

Therefore, the present invention can accurately evaluate the response capability reflecting the previous conversation context of the LLM in the RAG setting using the data generated for the specific capability evaluation of the LLM. Accordingly, it is possible to reduce labor costs and time by performing generation and review of the conversation context data through automation using the LLM, and it is not necessary to refer to all contents or all chunks of the target document when the conversation context data is generated, so that it is possible to reduce API call costs and GPU usage. In addition, it is possible to generate conversation context data having a consistent flow and context through a structured-type passage network, and it is possible to accurately evaluate how well the LLM configured in the RAG method stores and reflects the previous contents during the conversation to answer for the same.

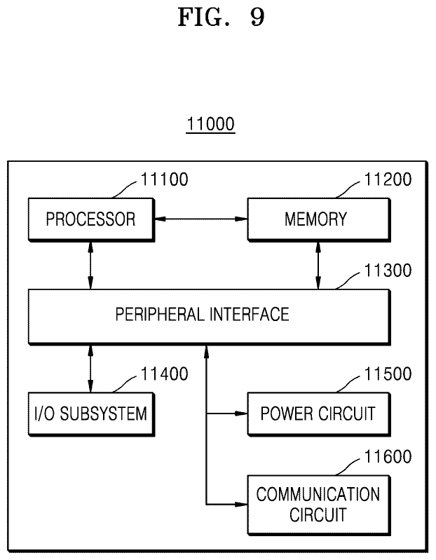

FIG. 9 schematically shows internal components of the computing device according to one embodiment of the present invention.

The computing device 1000 shown in the above-described FIG. 1 may include components of the computing device 11000 shown in FIG. 9.

As shown in FIG. 9, the computing device 11000 may at least include at least one processor 11100, a memory 11200, a peripheral device interface 11300, an input/output subsystem (I/O subsystem) 11400, a power circuit 11500, and a communication circuit 11600. The computing device 11000 may correspond to the computing device 1000 shown in FIG. 1.

The memory 11200 may include, for example, a high-speed random access memory, a magnetic disk, an SRAM, a DRAM, a ROM, a flash memory, or a non-volatile memory. The memory 11200 may include a software module, an instruction set, or other various data necessary for the operation of the computing device 11000.

The access to the memory 11200 from other components of the processor 11100 or the peripheral interface 11300, may be controlled by the processor 11100.

The peripheral interface 11300 may combine an input and/or output peripheral device of the computing device 11000 to the processor 11100 and the memory 11200. The processor 11100 may execute the software module or the instruction set stored in memory 11200, thereby performing various functions for the computing device 11000 and processing data.

The input/output subsystem may combine various input/output peripheral devices to the peripheral interface 11300. For example, the input/output subsystem may include a controller for combining the peripheral device such as monitor, keyboard, mouse, printer, or a touch screen or sensor, if needed, to the peripheral interface 11300. According to another aspect, the input/output peripheral devices may be combined to the peripheral interface 11300 without passing through the I/O subsystem.

The power circuit 11500 may provide power to all or a portion of the components of the terminal. For example, the power circuit 11500 may include a power failure detection circuit, a power converter or inverter, a power status indicator, a power failure detection circuit, a power converter or inverter, a power status indicator, or any other components for generating, managing, and distributing the power.

The communication circuit 11600 may use at least one external port, thereby enabling communication with other computing devices.

Alternatively, as described above, if necessary, the communication circuit 11600 may transmit and receive an RF signal, also known as an electromagnetic signal, including RF circuitry, thereby enabling communication with other computing devices.

The above embodiment of FIG. 9 is merely an example of the computing device 11000, and the computing device 11000 may have a configuration or arrangement in which some components shown in FIG. 9 are omitted, additional components not shown in FIG. 9 are further provided, or at least two components are combined. For example, a computing device for a communication terminal in a mobile environment may further include a touch screen, a sensor or the like in addition to the components shown in FIG. 9, and the communication circuit 11600 may include a circuit for RF communication of various communication schemes (such as WiFi, 3G, LTE, Bluetooth, NFC, and Zigbee). The components that may be included in the computing device 11000 may be implemented by hardware, software, or a combination of both hardware and software which include at least one integrated circuit specialized in a signal processing or an application.

The methods according to the embodiments of the present invention may be implemented in the form of program instructions to be executed through various computing devices, thereby being recorded in a computer-readable medium. In particular, a program according to an embodiment of the present invention may be configured as a PC-based program or an application dedicated to a mobile terminal. The application to which the present invention is applied may be installed in the computing device 11000 through a file provided by a file distribution system. For example, a file distribution system may include a file transmission unit (not shown) that transmits the file according to the request of the computing device 11000.

The above-mentioned device may be implemented by hardware components, software components, and/or a combination of hardware components and software components. For example, the devices and components described in the embodiments may be implemented by using at least one general purpose computer or special purpose computer, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and at least one software application executed on the operating system. In addition, the processing device may access, store, manipulate, process, and create data in response to the execution of the software. For the further understanding, some cases may have described that one processing device is used, however, it is well known by those skilled in the art that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, and an instruction, or a combination of at least one thereof, and may configure the processing device to operate as desired, or may instruct the processing device independently or collectively. In order to be interpreted by the processor or to provide instructions or data to the processor, the software and/or data may be permanently or temporarily embodied in any type of machine, component, physical device, virtual equipment, computer storage medium or device, or in a signal wave to be transmitted. The software may be distributed over computing devices connected to networks, so as to be stored or executed in a distributed manner. The software and data may be stored in at least one computer-readable recording medium.

The method according to the embodiment may be implemented in the form of program instructions to be executed through various computing mechanisms, thereby being recorded in a computer-readable medium. The computer-readable medium may include program instructions, data files, data structures, and the like, independently or in combination thereof. The program instructions recorded on the medium may be specially designed and configured for the embodiment, or may be known to those skilled in the art of computer software so as to be used. An example of the computer-readable medium includes a magnetic medium such as a hard disk, a floppy disk and a magnetic tape, an optical medium such as a CD-ROM and a DVD, a magneto-optical medium such as a floptical disk, and a hardware device specially configured to store and execute a program instruction such as ROM, RAM, and flash memory. An example of the program instruction includes a high-level language code to be executed by a computer using an interpreter or the like as well as a machine code generated by a compiler. The above hardware device may be configured to operate as at least one software module to perform the operations of the embodiments, and vice versa.

According to one embodiment of the present invention, it is possible to evaluate the response quality of the LLM through the conversation context data generated based on the target document.

According to one embodiment of the present invention, it is possible to extract the plurality of chunks from the target document and generate the passage node based on each chunk.

According to one embodiment of the present invention, it is possible to generate the passage network by deriving the connection relationship according to similarity between the passage nodes based on the embedding information.

According to one embodiment of the present invention, it is possible to generate the conversation context data including questions and answers based on the contents for the passage nodes.

According to one embodiment of the present invention, it is possible to derive the evaluation answer by inputting the contents for the passage nodes and the conversation context data into the evaluation target LLM.

According to one embodiment of the present invention, it is possible to derive the evaluation information about the evaluation target LLM based on the evaluation answer and the conversation context data.

According to one embodiment of the present invention, it is possible to manage the quality of conversation context data by reviewing the conversation context data through the LLM.

According to one embodiment of the present invention, it is possible to derive the evaluation information about the evaluation answer by comparing the similarity between the evaluation answer and the conversation context data.

According to one embodiment of the present invention, it is possible to derive the evaluation information about the evaluation answer by inputting the evaluation answer, the conversation context data, and the evaluation criterion information into the LLM.

Although the above embodiments have been described with reference to the limited embodiments and drawings, however, it will be understood by those skilled in the art that various changes and modifications may be made from the above-mentioned description. For example, even though the described descriptions may be performed in an order different from the described manner, and/or the described components such as system, structure, device, and circuit may be coupled or combined in a form different from the described manner, or replaced or substituted by other components or equivalents, appropriate results may be achieved.

Therefore, other implementations, other embodiments, and equivalents to the claims are also within the scope of the following claims.

What is claimed is:

1. A method for evaluating a response quality of an LLM, which is performed by a server system including one or more processors and one or more memories, the method comprising:
a chunk extraction step of extracting a plurality of chunks from a target document;
a passage network generation step of generating a plurality of passage nodes, each of which includes one or more chunks or information derived from the one or more chunks, and generating a passage network by deriving a connection relationship between the plurality of passage nodes according to similarity between the passage nodes;
a conversation context data generation step of generating conversation context data including one or more questions and answers corresponding to each of the questions, based on an arbitrary first passage node and contents for each of a plurality of passage nodes related to the first passage node according to the connection relationship;
an evaluation answer derivation step of deriving evaluation answers by inputting the contents for the first passage node and a part of the conversation context data into an evaluation target LLM; and
an evaluation information derivation step of deriving evaluation information based on the evaluation answers and the part of the conversation context data.

2. The method of claim 1, wherein the passage network generation step includes:
a step of generating contents by summarizing contents of each of the one or more chunks, and generating a plurality of passage nodes including contents thereof;
a step of deriving embedding information about each of the plurality of passage nodes, and calculating similarity between the respective passage nodes based on the embedding information;
a step of deriving a connection relationship between passage nodes having similarity that is equal to or greater than a preset reference; and
a step of generating the passage network including the plurality of passage nodes and the connection relationship between the respective passage nodes.

3. The method of claim 1, wherein the conversation context data generation step includes:
a step of generating a first question by selecting an arbitrary first passage node and inputting first content for the first passage node into the LLM;
a step of generating a first answer for the first question by inputting the first content and the first question into the LLM;
a step of generating a second question by inputting second content, the first question, and the first answer into the LLM with respect to the second content for any one of the passage nodes related to the first passage node; and
a step of generating a second answer for the second question by inputting the second content, the first question, the first answer, and the second question into the LLM,
wherein the first question, the first answer, the second question, and the second answer are included in the conversation context data.

4. The method of claim 1, further comprising a conversation context data review step of reviewing the conversation context data by inputting the conversation context data and the contents for each of the plurality of passage nodes to an LLM outside or inside the server system,
wherein the conversation context data review step includes:
a step of determining whether there is a content mismatch by comparing the conversation context data and the contents for each of the plurality of passage nodes; and
a step of determining whether there is an error in questions and answers included in the conversation context data.

5. The method of claim 1, wherein the conversation context data includes n questions and n answers,
the evaluation answer derivation step includes deriving the evaluation answers by inputting contents for a specific passage node, the n questions, and (n-1) answers into the evaluation target LLM, and
the evaluation information derivation step includes deriving the evaluation information based on one answer that is not input into the evaluation target LLM in the evaluation answer derivation step and the evaluation answers derived from the evaluation target LLM.

6. The method of claim 1, wherein the evaluation information derivation step includes deriving evaluation information about the evaluation answers by comparing an answer that is not input into the evaluation target LLM in the evaluation answer derivation step and similarity between the evaluation answers.

7. The method of claim 1, wherein the evaluation information derivation step includes deriving evaluation information about the evaluation answers by inputting the evaluation answers, the part of the conversation context data, and preset evaluation reference information into the LLM.

8. A server system, which includes one or more processors and one or more memories, for evaluating a response quality of an LLM, the server system comprising:
a chunk extraction unit configured to extract a plurality of chunks from a target document;
a passage network generation unit configured to generate a plurality of passage nodes, each of which includes one or more chunks or information derived from the one or more chunks, and generate a passage network by deriving a connection relationship between the plurality of passage nodes according to similarity between the passage nodes;
a conversation context data generation unit configured to generate conversation context data including one or more questions and answers corresponding to each of the questions, based on an arbitrary first passage node and contents for each of a plurality of passage nodes related to the first passage node according to the connection relationship;
an evaluation answer derivation unit configured to derive evaluation answers by inputting the contents for the first passage node and a part of the conversation context data into an evaluation target LLM; and
an evaluation information derivation unit configured to derive evaluation information based on the evaluation answers and the part of the conversation context data.

9. A non-transitory computer-readable storage medium storing computer-executable instructions that, when executed by a server system including one or more processors and one or more memories, cause the server system to perform operations for evaluating a response quality of an LLM, wherein the operations comprise:
a chunk extraction step of extracting a plurality of chunks from a target document;
a passage network generation step of generating a plurality of passage nodes, each of which includes one or more chunks or information derived from the one or more chunks, and generating a passage network by deriving a connection relationship between the plurality of passage nodes according to similarity between the passage nodes;
a conversation context data generation step of generating conversation context data including one or more questions and answers corresponding to each of the questions, based on an arbitrary first passage node and contents for each of a plurality of passage nodes related to the first passage node according to the connection relationship;
an evaluation answer derivation step of deriving evaluation answers by inputting the contents for the first passage node and a part of the conversation context data into an evaluation target LLM; and
an evaluation information derivation step of deriving evaluation information based on the evaluation answers and the part of the conversation context data.
